(19) United States
(12) Patent Application Publication
(10) Pub. No.: US 2020/0090698 A1
(43) Pub. Date: Mar. 19, 2020

(54) MAGNETIC DISK DEVICE AND METHOD FOR OPTIMIZING RECORDING CURRENT

(71) Applicants: TOSHIBA ELECTRONIC DEVICES & STORAGE CORPORATION, Tokyo (JP); KABUSHIKI KAISHA TOSHIBA, Tokyo (JP)

(72) Inventor: Hirokazu SHOU, Musashimurayama Tokyo (JP)

(21) Appl. No.: 16/291,737

(22) Filed: Mar. 4, 2019

(30) Foreign Application Priority Data
Sep. 19, 2018 (JP) 2018-175241

(51) Int. Cl. G11B 20/10; G11B 19/04; G11B 27/36; G11B 19/06; G11B 5/09

(52) U.S. Cl. CPC G11B 20/10481; G11B 19/046; G11B 2220/2516; G11B 19/06; G11B 5/09; G11B 27/36

(57) ABSTRACT

A magnetic disk device includes a magnetic disk that includes a plurality of zones divided in a radial direction, a plurality of tracks in each of the zones, and a plurality of sectors in each of the tracks divided in a circumferential direction, a magnetic head configured to read and write data to and from the magnetic disk, and a control unit configured to determine a setting value of a recording current to be applied to the magnetic head when writing to each of a plurality of sections of a first sector, based on error rates in data read from a second sector that is in the same zone as the first sector and to which a write was performed while changing setting values of recording currents applied to the magnetic head while writing to each of a plurality of sections of the second sector.

### CROSS-REFERENCE TO RELATED APPLICATIONS

This application is based upon and claims the benefit of priority from Japanese Patent Application No. 2018-175241, filed Sep. 19, 2018, the entire contents of which are incorporated herein by reference.

### FIELD

Embodiments described herein relate generally to a magnetic disk device and a method for optimizing a recording current.

### BACKGROUND

A magnetic disk device is widely used as a storage device for a computer. In this magnetic disk device, data is recorded by rotating a magnetic disk made of aluminum or glass coated with a magnetic material at high speed by a motor and irradiating a track on the magnetic disk with a magnetic field by a magnetic head.

The track pitch of the magnetic disk has been becoming narrower so as to increase the recording density of the magnetic disk. However, this may cause deterioration of data stored in such tracks as a result of data writing to adjacent tracks.

### DESCRIPTION OF THE DRAWINGS

FIG. 1 is a diagram showing an overall configuration of a magnetic disk device according to a first embodiment.

FIG. 2 is a diagram showing a configuration of the magnetic disk and optimization of a write current value according to the first embodiment.

FIG. 3 is a flowchart showing an example of a procedure of a write current optimization process in the magnetic disk device according to the first embodiment.

FIG. 4 is a flowchart showing an example of a procedure of a write current determination process of a write current determination unit according to the first embodiment.

FIG. 5 is a flowchart showing an example of a procedure of a write current optimization process in a magnetic disk device according to the second embodiment.

FIG. 6 is a flowchart showing an example of a procedure of a write current optimization process in a magnetic disk device according to the third embodiment.

### DETAILED DESCRIPTION

Embodiments provide a magnetic disk device and a method for optimizing a recording current capable of preventing deterioration of data stored in a track as a result of writing data to an adjacent track.

In general, according to one embodiment, a magnetic disk device according to an embodiment includes a magnetic disk that includes a plurality of zones divided in a radial direction, a plurality of tracks in each of the zones, and a plurality of sectors in each of the tracks divided in a circumferential direction, a magnetic head configured to read and write data to and from the magnetic disk, and a control unit configured to determine a setting value of a recording current to be applied to the magnetic head when writing to each of a plurality of sections of a first sector, based on error rates in data read from a second sector that is in the same zone as the first sector and to which a write was performed while changing setting values of recording currents applied to the magnetic head while writing to each of a plurality of sections of the second sector.

Hereinafter, the present disclosure will be described in detail with reference to the drawings. It should be noted that the present disclosure is not limited to the following embodiments. In addition, constituent elements in the following embodiments include those can be easily conceived by those skilled in the art or those are substantially the same.

In the following description, the terms such as write, writing, and recording have substantially the same meaning. In addition, the terms such as read, reading, reproducing have substantially the same meaning.

### First Embodiment

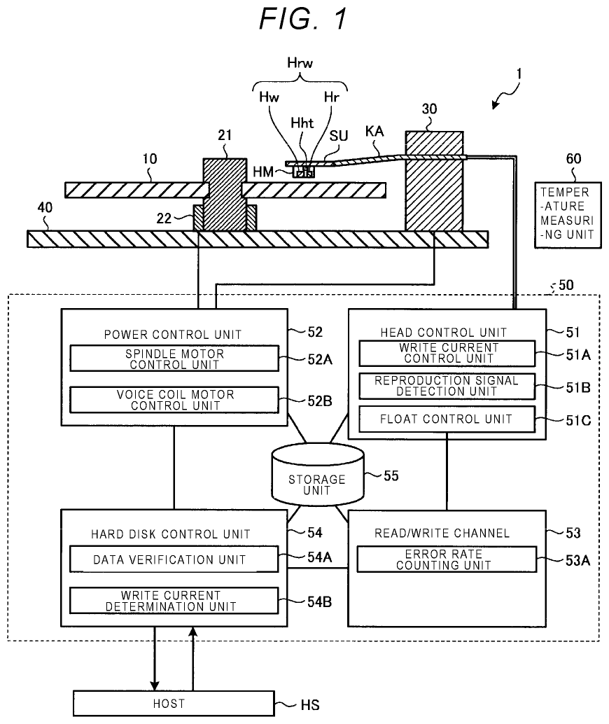

The first embodiment will be described with reference to FIGS. 1 to 4.

(Overall Configuration of Magnetic Disk Device) FIG. 1 is a diagram showing an overall configuration of a magnetic disk device 1 according to the first embodiment. The magnetic disk device 1 is, for example, a hard disk drive externally attached to a host HS or incorporated therein.

As shown in FIG. 1, the magnetic disk device 1 includes a magnetic disk 10, a spindle 21, a spindle motor 22, a head slider HM, a suspension SU, a carriage arm KA, a voice coil motor 30, a base 40, and a control unit 50. The magnetic disk device 1 further includes a temperature measuring unit 60 (which includes a temperature sensor and is, e.g., implemented as a dedicated circuit) that measures the internal temperature of the magnetic disk device 1 under control of the control unit 50.

The magnetic disk 10 is a disk-shaped recording medium on which various information are recorded magnetically, and is rotationally driven by the spindle motor 22. The magnetic disk 10 includes, for example, a plurality of concentric zones centered on a position near a rotation center of the spindle motor 22. Further, each zone includes a plurality of concentric tracks. A detailed configuration of the magnetic disk 10 will be described later.

The head slider HM is disposed above the magnetic disk 10. The head slider HM is provided with a magnetic head Hrw and a heater Hht. The magnetic head Hrw includes a read head Hr and a write head Hw. The read head Hr and the write head Hw are disposed so as to face the magnetic disk 10 at a position spaced from the magnetic disk 10 by about several nanometers.

The head slider HM is held above the magnetic disk 10 via the suspension SU and the carriage arm KA. The carriage arm KA slides the head slider HM along a horizontal plane during seeking to search a target position or the like. The suspension SU maintains a constant floating distance with respect to the magnetic disk 10 such that the head slider HM does not come into contact with the magnetic disk 10 due to an air flow that is generated when the magnetic disk 10 is rotating. That means a desired floating distance is generated in the magnetic head Hrw with respect to the magnetic disk 10. The suspension SU is implemented by, for example, a leaf spring.

In addition, the head slider HM has a material that expands and contracts due to heat. By applying heat to the heater Hht, the head slider HM expands, and the floating distance between the magnetic disk 10 and the magnetic head Hrw generated by the rotation of the magnetic disk 10 is changed.

The voice coil motor 30 drives the carriage arm KA. The spindle motor 22 rotates the magnetic disk 10 centered on the spindle 21. The voice coil motor 30 and the spindle motor 22 are fixed to the base 40.

The control unit 50 includes a hardware processor such as a CPU (Central Processing Unit) and a memory such as a ROM (Read Only Memory) or a RAM (Random Access Memory).

The control unit 50 includes a head control unit 51, a power control unit 52, a read/write channel 53, a hard disk control unit 54, and a storage unit 55, and controls each unit of the magnetic disk device 1. The head control unit 51, the power control unit 52, the read/write channel 53, and the hard disk control unit 54 may be implemented by the CPU executing a program or may be implemented as dedicated hardware circuits. Further, the storage unit 55 may be implemented by a ROM, a RAM, or the like.

The head control unit 51 includes a write current control unit 51A and a reproduction signal detection unit 51B, and amplifies or detects a signal during recording/reproduction. The write current control unit 51A controls a write current (also referred to as recording current) flowing through the write head Hw. The reproduction signal detection unit 51B detects a signal read by the read head Hr. Further, the head control unit 51 includes a float control unit 51C. The float control unit 51C is set with a setting value of the floating distance optimal for each zone stored in the storage unit 55 via the hard disk control unit 54, and the float control unit 51C controls the heater Hht, thereby keeping the floating distance between the magnetic disk 10 and the magnetic head Hrw constant.

The power control unit 52 includes a spindle motor control unit 52A and a voice coil motor control unit 52B, and drives the spindle motor 22 and the voice coil motor 30. The spindle motor control unit 52A controls the rotation of the spindle motor 22. The voice coil motor control unit 52B controls the driving of the voice coil motor 30.

The read/write channel 53 transfers data between the head control unit 51 and the hard disk control unit 54. The data includes read data, write data, and servo data. For example, the read/write channel 53 converts a signal reproduced (read) by the read head Hr into a data format handled by the host HS, and converts data output from the host HS into a signal format to be recorded (written) by the write head Hw. In addition, the read/write channel 53 performs a decoding process on the signal read by the read head Hr, and code-modulates the data output from the host HS.

The read/write channel 53 includes an error rate counting unit 53A. The error rate counting unit 53A measures an error rate in the data written to the magnetic disk 10 when the data is read. The error rate is a rate of the number of error bits with respect to the number of write bits.

The hard disk control unit 54 performs recording and reproducing control based on a command from the host HS, and transfers the data between the host HS and the read/write channel 53, for example. The hard disk control unit 54 includes a data verification unit 54A and a write current determination unit 54B. The data verification unit 54A determines whether data in the magnetic disk 10 can be read correctly, and accordingly, determines whether the data has been correctly written to the magnetic disk 10. The write current determination unit 54B determines an appropriate write current value in a predetermined recording area in a track provided in the magnetic disk 10.

The storage unit 55 stores various setting parameter groups necessary for the operation of the magnetic disk device 1, set parameters of the write current used by the write current determination unit 54C, and the like.

The control unit 50 is connected to the host HS. The host HS may be a personal computer that issues a write command and a read command to the magnetic disk device, or may be a network connectable to a server or the like.

In the magnetic disk device 1 configured as described above, while the magnetic disk 10 is rotated by the spindle motor 22, a signal is read from the magnetic disk 10 via the magnetic head Hrw and detected by the reproduction signal detection unit 51B. The signal detected by the reproduction signal detection unit 51B is converted into data by the read/write channel 53, and then sent to the hard disk control unit 54. In the hard disk control unit 54, tracking control of the magnetic head Hrw is performed based on servo data included in the signal detected by the reproduction signal detection unit 51B.

In addition, a current position of the magnetic head Hrw is calculated based on the servo data detected by the reproduction signal detection unit 51B, and seek control is performed such that the magnetic head Hrw approaches the target position. When the magnetic head Hrw reaches the target position, a signal is read from the magnetic disk 10 via the magnetic head Hrw, or data is written to the magnetic disk 10.

(Configuration of Magnetic Disk and Optimization of Write Current Value)

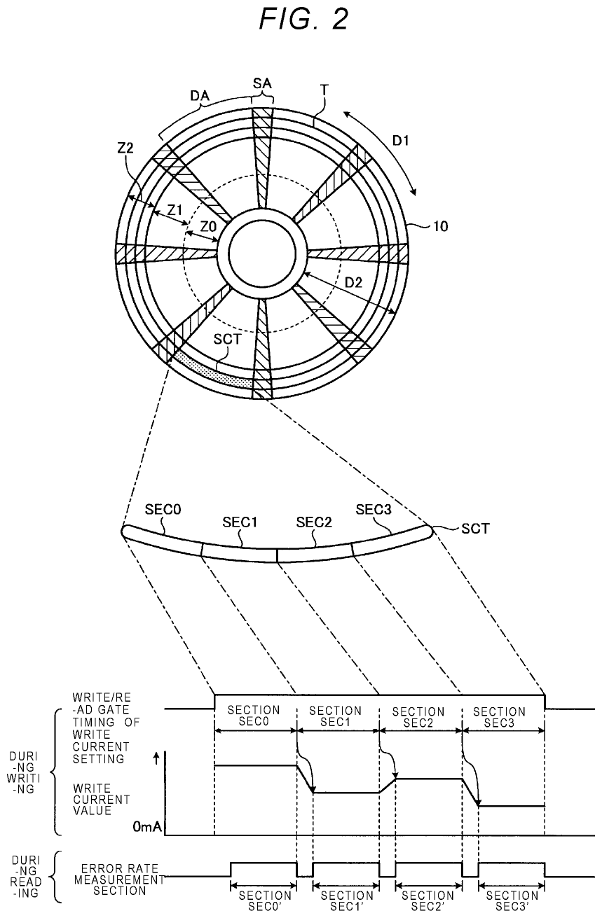

Next, the configuration example of the magnetic disk 10 according to the first embodiment will be described with reference to FIG. 2. FIG. 2 is a diagram showing the configuration of the magnetic disk 10 and the optimization of a write current value according to the first embodiment. An upper part of FIG. 2 is a plan view of the magnetic disk 10, a middle part is an enlarged view of a sector SCT in the magnetic disk 10, and a lower part is a view showing a timing of write and read for optimizing a write current value in the sector SCT in the magnetic disk 10.

As shown in the upper part of FIG. 2, along a radial direction D2, the magnetic disk 10 includes a plurality of tracks T each extending along a circumferential direction D1. In each track T, a data area DA in which user data are written and a servo area SA in which servo data are written are provided. The servo area SA is disposed radially, for example, and a data area DA is disposed between servo areas SA along the circumferential direction D1. The data area DA sandwiched between two adjacent servo areas SA of each track T includes a plurality of areas called sectors SCT. The sector SCT is a minimum recording unit according to a logical format of the magnetic disk 10.

In addition, the magnetic disk 10 is divided into, for example, zones Z0 to Z2 in the radial direction D2. The outermost zone is the zone Z2, and the innermost zone is the zone Z0. However, the number of zones Z0 to Z2 is not limited thereto. In each of the zones Z0 to Z2, suitable values of various setting parameters of the write current as a recording current are set. These setting parameters are parameters for determining a write current waveform, that is, parameters relating to a magnetic flux density necessary for forming a magnetic pole of the data written to the magnetic disk 10. These setting parameters are stored in the storage unit 55 of the control unit 50 described above.

The setting parameters of the write current include, for example, a current value to be applied to the magnetic disk 10, an overshoot current value and an overshoot maintenance time for limiting an overshoot amount of the write current, and a start timing and an end timing of the write current waveform. These setting parameters are individually prepared in the storage unit 55 according to a length of a data pattern to be written, in other words, a pattern such as whether the write current waveform is high frequency or low frequency.

When the write command to the magnetic disk 10 is transferred from the host HS, the write current determination unit 54B of the hard disk control unit 54 makes at least the write current value more appropriate at a predetermined timing to be described later among the suitable values of the setting parameters of the write currents of the zones Z0 to Z2.

At that time, as shown in the middle part of FIG. 2, the write current determination unit 54B divides a write target sector SCT into a plurality of sections SEC 0 to SEC 3. The sections SEC 0 to SEC 3 are logical. In addition, in the example of FIG. 2, four sections SEC 0 to SEC 3 are shown, but there may be three or less, or five or more sections.

In an actual write operation, as shown in the lower part of FIG. 2, the write current determination unit 54B writes data with different write current values to the sections SEC 0 to SEC 3 of this sector SCT, respectively. These different write current values include, for example, an initial value, that is, a write current value set in advance in a zone to which the sector SCT belongs. Further, it is preferable that a range of these different write current values is smaller than the initial value. The setting of these different write current values is read from the storage unit 55, for example.

Specifically, first, the spindle motor control unit 52A and the voice coil motor control unit 52B move the magnetic head Hrw to the target track T of the magnetic disk 10. Subsequently, when the magnetic head Hrw passes through the target sector SCT, the read/write channel 53 outputs a write gate signal. While the write gate signal is being output, the units of the magnetic disk device 1 perform a write operation. Then, the write current determination unit 54B monitors a head position of each of the sections SEC 0 to SEC 3 and sets the setting value read from the storage unit 55 to the write current control unit 51A at the head position of each of the sections SEC 0 to SEC 3. The write current control unit 51A controls the write current that is read from the storage unit 55 and is set by the write current determination unit 54B, while the magnetic head Hrw writes data to the respective sections SEC 0 to SEC 3 with different write current values.

At this time, when different write currents are applied to the magnetic head Hrw in the respective sections SEC 0 to SEC 3, a heat generation amount of the write head Hw changes according to the different write currents. Even if the floating distance between the magnetic disk 10 and the magnetic head Hrw is to be controlled to be constant by the heater Hht, as the heat generation amount of the write head Hw increases, an expansion state of the slider HM changes and along with the change of the write current, the floating distance of the magnetic head Hrw changes for each of the sections SEC 0 to SEC 3. Therefore, the floating distance between the magnetic disk 10 and the magnetic head Hrw is corrected by the heater Hht according to the different write currents such that the floating distance does not change for each of the sections SEC 0 to SEC 3. More specifically, for example, the floating distance is corrected by setting the write current and the setting value of the floating distance, which are read from the storage unit 55, from the write current determination unit 54B to the write current control unit 51A and the float control unit 51C at the head position of each of the sections SEC 0 to SEC 3, such that the floating distance of the magnetic head Hrw does not change. It should be noted that it takes a predetermined time until the write current value actually reaches the setting value from the setting change of the write current value, and that a section required for the stabilization of the write current value occurs at the head portion of each of the sections SEC 0 to SEC 3.

Accordingly, when the write operation is performed, the write current determination unit 54B acquires an error rate and a result of data verification of each of the sections SEC 0 to SEC 3 of this sector SCT, and determines a write current value of the zone to which the write target sector SCT belongs, to be appropriate based on these results.

Specifically, first, the spindle motor control unit 52A and the voice coil motor control unit 52B move the magnetic head Hrw to the target track T of the magnetic disk 10. Subsequently, when the magnetic head Hrw passes through the target sector SCT, the read/write channel 53 outputs a read gate signal. While the read gate signal is being output, the units of the magnetic disk device 1 perform a read operation. Then, the read/write channel 53 reads the signal read from the target sector SCT of the magnetic disk 10 via the reproduction signal detection unit 51B.

At this time, the error rate counting unit 53A measures the error rate of the sector SCT. The error rate is measured in each of the sections SEC 0 to SEC 3 based on the number of bits and the number of error bits corresponding to each of the sections SEC 0 to SEC 3 among the number of bits written in the sector SCT. The number of error bits corresponding to each of the sections SEC 0 to SEC 3 is preferably set to the number of error bits corresponding to sections SEC 0′ to SEC 3′ excluding a section where the write current is not stable at the head positions of the respective sections SEC 0 to SEC 3. In addition, the data verification unit 54A determines whether the data can be read correctly simultaneously with the error rate measurement in each of the sections SEC 0 to SEC 3 of the sector SCT, that is, determines whether the data has been correctly written.

As a result of the data verification, if no write abnormality occurs, the write current determination unit 54B determines, for example, a minimum write current value among the write current values whose error rates are equal to or smaller than a predetermined threshold value, as a write current value to be applied to the zone to which the sector SCT belongs.

The predetermined threshold value for determining whether the error rate is acceptable may be set to an allowable value up to about 110, for example, assuming that an error rate obtained at the time of writing with a write current value preset in the zone to which the sector SCT belongs is 100. The allowable value is preferably added with a variation in error rate generated due to a variation in recording sensitivity of the magnetic disk 10 in the zone to which the sector SCT belongs, or a variation in recording sensitivity of the magnetic disk 10 in the track T to which the sector SCT belongs.

As a result of the data verification, when write abnormality occurs, the write current determination unit 54B determines a write current value of the zone stored in the storage unit 55, that is, determines an initial value as the write current value to be applied to the zone. In addition, when write abnormality occurs, data is written again to the sector SCT with the determined write current value of the zone stored in the storage unit 55.

Accordingly, the determined write current value is applied at the time of writing data to the sector SCT or the track T belonging to the zone until the next optimization process of the write current value is performed.

Such optimization of the write current value is performed when the write command is transferred from the host HS to the magnetic disk 10 and, for example, when the internal temperature of the magnetic disk device 1 fluctuates by a predetermined temperature from a time at which the previous write current value is determined. Alternatively, the optimization of the write current may be performed when a write command is transferred from the host HS to the magnetic disk 10 and, for example, after a predetermined time passes from the previous optimization process.

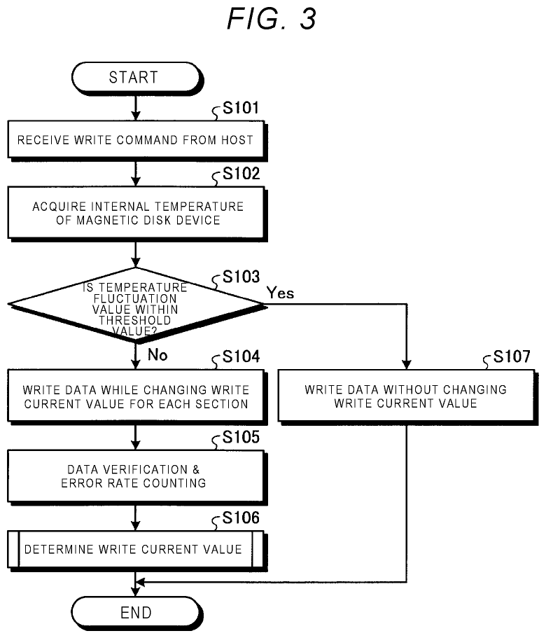

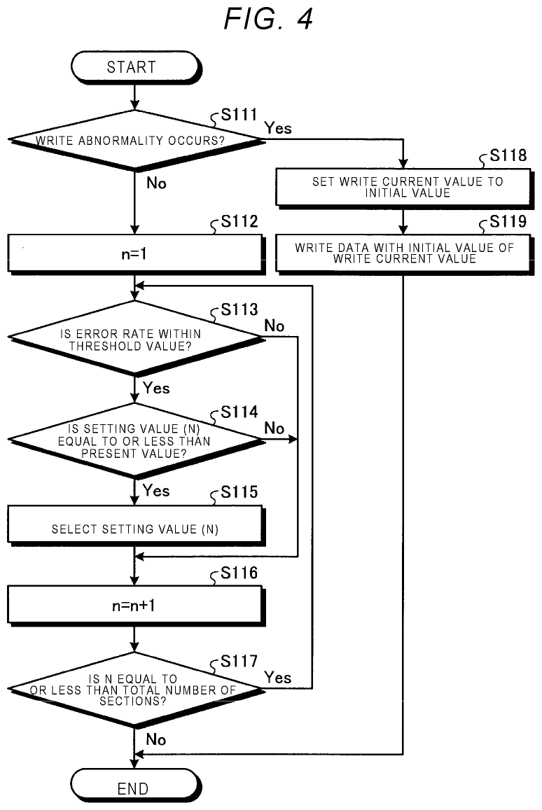

(Example of Write Current Determination Process) Next, with reference to FIG. 3 and FIG. 4, an example of the write current optimization process in the magnetic disk device 1 according to the first embodiment will be described. FIG. 3 is a flowchart showing an example of the procedure of the write current optimization process in the magnetic disk device 1 according to the first embodiment. The flowchart of FIG. 3 is an example where the optimization of the write current value is performed when a write command is transferred from the host HS to the magnetic disk 10, and when the internal temperature of the magnetic disk device 1 fluctuates by the predetermined temperature from the time at which the previous write current value is determined.

As shown in FIG. 3, when receiving a write command from the host HS (step S101), the control unit 50 acquires an internal temperature of the magnetic disk device 1 from the temperature measuring unit 60 (step S102). The control unit 50 determines how much the internal temperature of the magnetic disk device 1 fluctuates from the time of the optimization of the previous write current value (step S103).

When the fluctuation value of the internal temperature of the magnetic disk device 1 is within a predetermined threshold value (step S103: Yes), the control unit 50 does not change the setting of the write current value, and writes data with the currently set write current value (step S107).

When the fluctuation value of the internal temperature of the magnetic disk device 1 is out of the predetermined threshold value (step S103: No), the write current determination unit 54B reads the setting of the plurality of different write current values from the storage unit 55, and the units of the magnetic disk device 1 write the data with the different write current values to the sections SEC 0 to SEC 3 of the write target sector SCT (step S104).

When writing to the write target sector SCT is completed, the write current determination unit 54B causes the units of the magnetic disk device 1 to read the written data of each of the sections SEC 0 to SEC 3 of the sector SCT. At this time, the data verification unit 54A verifies whether the data of each of the sections SEC 0 to SEC 3 are correctly written. In addition, the error rate counting unit 53A measures the error rate in the data of each of the sections SEC 0 to SEC 3 (step S105).

The write current determination unit 54B acquires the result of verification performed by the data verification unit 54A and the error rate measured by the error rate counting unit 53A, and determines a write current value to be applied to the zone from the write current values used for the sections SEC 0 to SEC 3 of the sector SCT or the write current value preset in the zone to which the sector SCT belongs (step S106).

Thus, the write current optimization process in the magnetic disk device 1 ends.

As described above, regardless of the example of FIG. 3, the optimization of the write current value may be performed when a write command is transferred from the host HS, and after the predetermined time passes from the previous optimization process of the write current value.

FIG. 4 is a flowchart showing an example of the procedure of a write current determination process of the write current determination unit 54B according to the first embodiment. The flowchart of FIG. 4 corresponds to the details of step S106 of the flowchart of FIG. 3. In addition, the flowchart of FIG. 4 is an example in which the minimum write current value among write current values whose error rates fall within the predetermined threshold is determined as the write current value to which the zone is applied.

As shown in FIG. 4, the write current determination unit 54B determines whether write abnormality occurs based on the result of the verification performed by the data verification unit 54A (step S111). If the write abnormality does not occur (step S111: No), the write current determination unit 54B performs the following processes so as to determine a suitable write current value among those used for writing in each of the sections SEC 0 to SEC 3 of the sector SCT.

The write current determination unit 54B sets n to 1 (step S112), and successively examines the suitability of the write current values from a first write current value used in the first section SEC 0. That is, the write current determination unit 54B acquires an error rate of an n-th section SECn written with an n-th write current value (hereinafter also referred to as the setting value (n)) from the error rate counting unit 53A, and determines whether such an error rate is within a predetermined threshold value (step S113). When the error rate is out of the predetermined threshold value (step S113: No), the setting value (n) is not the suitable value, so that the process proceeds to step S116 and the process proceeds to the examination of the next setting value (n+1).

When the error rate is within the predetermined threshold value (step S113: Yes), it is determined as to whether the setting value (n) is equal to or smaller than a present value, that is, a write current value currently applied to the zone to which an evaluation target sector SCT belongs (step S114).

When the setting value (n) under examination is larger than the present value (step S114: No), the influence of the present value on the adjacent track T is smaller than that of the setting value (n). Therefore, without selecting the setting value (n), the write current determination unit 54B sets n to n+1 (step S116), and if a newly obtained n is a numerical value equal to or smaller than the total number of sections (step S117: Yes), the process proceeds to the examination of the next setting value (n) (to step S113).

When the setting value (n) under examination is smaller than the present value (step S114: Yes), the influence of the setting value (n) on the adjacent track T is smaller than that of the present value. Therefore, after selecting the setting value (n) under examination (step S115), n is updated to n+1 and the process proceeds to the examination of the next setting value (n) (to step S113).

By repeating the above steps S113 to S117 until n reaches the total number of sections, the minimum write current value among the write current values whose error rates fall within the predetermined threshold value is determined as a write current value to be applied in the zone to which the evaluation target sector SCT belongs. If n exceeds the total number of sections (step S117: No), the write current determination unit 54B ends the process.

On contrast, when it is determined that write abnormality occurs based on the result of verification performed by the data verification unit 54A (step S111: Yes), the write current determination unit 54B determines an initial value, that is, a write current value preset in the zone to which the evaluation target sector SCT belongs, as the write current value to be applied to the zone without selecting any of the setting values (n) used this time in writing to the sections SEC 0 to SEC 3 of the sector SCT (step S118).

Further, the write current determination unit 54B again causes the units of the magnetic disk device 1 to rewrite the data from the host HS to the sector SCT with the initial value of the write current value (step S119).

Thus, the write current determination process of the write current determination unit 54B ends.

### Comparative Example

For example, in a magnetic disk device of a comparative example, the write current value to be applied to each zone is predetermined. When the ambient temperature, that is, the temperature in the magnetic disk device greatly fluctuates, a suitable value obtained by calculation based on the predetermined write current value is applied.

However, in recent years, as the recording sensitivity of the magnetic disk increases and the narrow track pitching progresses, and accordingly, it is impossible to sufficiently prevent the deterioration of data stored in the track adjacent to a track to be written.

In the magnetic disk device 1 according to the first embodiment, the write current value to be applied to a predetermined zone at a predetermined timing is optimized. Accordingly, deterioration of data stored in the adjacent track T due to the writing of data to the predetermined track T is prevented. In other words, the frequency of a refresh process of the adjacent track T is reduced. Here, the refresh process is to rewrite the existing data of the adjacent track T before being damaged.

In the magnetic disk device 1 according to the first embodiment, when a write command from the host HS is transferred to the magnetic disk 10 and, for example, when the temperature in the magnetic disk device 1 fluctuates, the write current value to be applied to the zone which belongs to the write target sector SCT is optimized. However, the time it takes to write when also optimizing the write current value is two or more times the time it takes for normal writing without the optimization. By defining as described above, the frequency of optimization of the write current value is kept at an appropriate frequency, and the performance of the magnetic disk device 1 is prevented from deteriorating.

In the magnetic disk device 1 according to the first embodiment, the optimization process of the write current value is incorporated into the normal write process, that is, a write process according to the write command from the host HS. For example, when the optimization of the write current value is performed separately from the normal write process, it is necessary to separately prepare data for the optimization process and to provide an area for the optimization process on the magnetic disk. By incorporating the optimization process of the write current value into the normal write process, it is not necessary to perform such a complicated process, and the data area of the magnetic disk 10 is not compressed.

### Second Embodiment

Next, the second embodiment will be described. In the following description, the same reference numerals are attached to the configurations corresponding to those in the above-described the first embodiment with reference to FIGS. 1 and 2. The magnetic disk device 1 according to the second embodiment is different from that according to the above-described the first embodiment in that the optimization of the write current value is performed along with a refresh process.

In the magnetic disk device 1, for example, the refresh process may be performed on a track T adjacent to a track T to be written. As described above, the refresh process is an operation of rewriting the data of the adjacent track T in advance before the data of the adjacent track T changes, in order to prevent data deterioration in the adjacent track T. The frequency of the refresh process is specified, for example, such that the refresh process is performed every time the number of times of writing to a predetermined track T reaches a predetermined number. In the magnetic disk device 1 according to the second embodiment, the optimization of the write current value is performed at the time of rewrite in the refresh process.

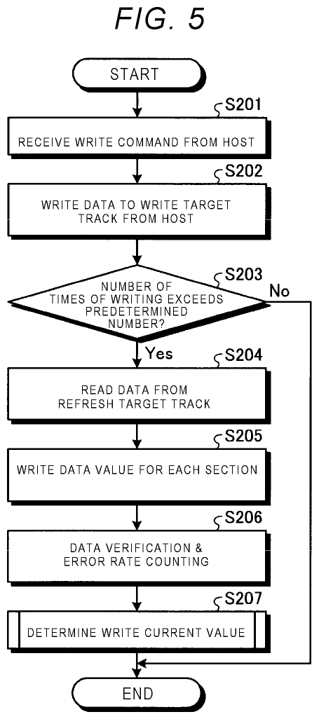

FIG. 5 is a flowchart showing an example of the procedure of the write current optimization process in the magnetic disk device 1 according to the second embodiment.

As shown in FIG. 5, when receiving a write command from the host HS to the predetermined track T (step S201), the control unit 50 writes the data to the target track T of the write command from the host HS (step S202). Subsequently, it is determined whether the number of times of writing to the track T exceeds a predetermined number (step S203). When the number of times of writing is within the predetermined number (step S203: No), the control unit 50 determines that the refresh process to the adjacent track T of the write target track T is unnecessary, and ends the process. When the number of times of writing exceeds the predetermined number (step S203: Yes), the control unit 50 determines that the refresh process to the adjacent track T is necessary, and performs the following processes.

That is, the control unit 50 reads data from the adjacent track T which is a refresh target track T (step S204), and stores the read data in the storage unit 55 of the control unit 50, for example. Next, along with the rewrite operation of the data read from the adjacent track T and stored in the storage unit 55, the write current determination unit 54B reads the setting of a plurality of different write current values from the storage unit 55, and causes the units of the magnetic disk device 1 to write data to, for example, the sections SEC 0 to SEC 3 of a head sector SCT of the refresh target track T with the different write current values (step S205). Further, the sector SCT in which the sections SEC 0 to SEC 3 are provided and are written with the different write current values is not necessarily the head sector SCT of the refresh target track T.

When writing to the head sector SCT of the refresh target track T is completed, the write current determination unit 54B causes the units of the magnetic disk device 1 to read the written data of each of the sections SEC 0 to SEC 3 of the sector SCT. At this time, the data verification unit 54A verifies whether the data of each of the sections SEC 0 to SEC 3 are correctly written. In addition, the error rate counting unit 53A measures the error rate in the data of each of the sections SEC 0 to SEC 3 (step S206).

The write current determination unit 54B acquires the result of verification performed by the data verification unit 54A and the error rate measured by the error rate counting unit 53A, and determines a write current value to be applied to the zone from the write current values used for the sections SEC 0 to SEC 3 of the sector SCT or the write current value preset in the zone to which the sector SCT belongs (step S207). Further, the write current determination process of the write current determination unit 54B in step S207 follows the flowchart of FIG. 4 described above.

Thus, the write current optimization process in the magnetic disk device 1 according to the second embodiment ends.

The magnetic disk device 1 according to the second embodiment also achieves the same effect as that of the first embodiment.

### Third Embodiment

Next, the third embodiment will be described. In the following description, the same reference numerals are attached to the configurations corresponding to those in the above-described the first embodiment with reference to FIGS. 1 and 2. The magnetic disk device 1 according to the third embodiment is different from those according to the above-described the first and second embodiments in that the optimization of the write current value is performed along with a read inspection of the magnetic disk 10.

In the magnetic disk device 1, a state where a command is exhausted, that is, a state where a command is not transferred from the host HS may occur. In such a command-exhausted state, for example, the magnetic disk device 1 performs a read inspection of the magnetic disk 10 in some cases. In the read inspection, for example, with the whole area of the magnetic disk 10 as a target, it is inspected as to whether the data can be read without any problem. When the data read from the magnetic disk 10 at the time of reading of the predetermined track T cannot be read correctly and a process of repeating the reading a plurality of times, that is, a retry process occurs to read the data correctly, the data may deteriorate. Hence, the magnetic disk device 1 rewrites the data to the track T for which the retry process is performed the predetermined number of times or more and from which finally the data are read correctly. In the magnetic disk device 1 according to the third embodiment, the optimization of the write current value is performed at the time of rewriting in the read inspection of the magnetic disk 10.

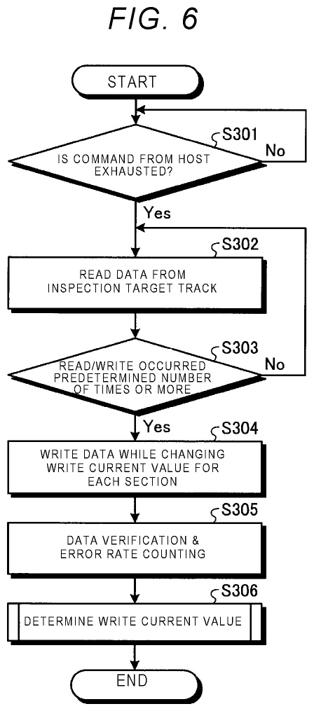

FIG. 6 is a flowchart showing an example of the procedure of the write current optimization process in the magnetic disk device 1 according to the third embodiment.

As shown in FIG. 6, the control unit 50 determines whether the magnetic disk device 1 is in the state where commands from the host HS are exhausted (which may be referred to as a “command-exhausted state”) (step S301). If the magnetic disk device 1 is not in the command-exhausted state (step S301: No), the control unit 50 waits until the magnetic disk device 1 enters the exhausted state. If the magnetic disk device 1 is in the command-exhausted state (step S301: Yes), the read inspection is performed on the entire area of the magnetic disk 10 as described below.

That is, the control unit 50 reads data from an inspection target track T (step S302). At this time, it is determined as to whether the retry process occurs in the data read (step S303). If the retry process does not occur the predetermined number of times or more (step S303: No), the next tracks T are successively set as inspection targets. To the track T for which the retry process is performed the predetermined number of times or more and from which finally the data are read correctly (step S303: Yes), the read data is rewritten. At this time, the optimization of the write current value is performed. Further, when the data cannot be read correctly even if the retry process reaches a predetermined upper limit of the number of times of the retry process, the next track T is set as the inspection target.

The write current determination unit 54B reads the setting of the plurality of different write current values from the storage unit 55, and causes the units of the magnetic disk device 1 to write data to, for example, the sections SEC 0 to SEC 3 of the head sector SCT of the rewrite target track T with the different write current values (step S304). Further, the sector SCT in which the sections SEC 0 to SEC 3 are provided and are written with the different write current values is not necessarily the head sector SCT of the refresh target track T.

When writing to the head sector SCT of the rewrite target track T is completed, the write current determination unit 54B causes the units of the magnetic disk device 1 to read the written data of each of the sections SEC 0 to SEC 3 of the sector SCT. At this time, the data verification unit 54A verifies whether the data of each of the sections SEC 0 to SEC 3 are correctly written. In addition, the error rate counting unit 53A measures the error rate in the data of each of the sections SEC 0 to SEC 3 (step S305).

The write current determination unit 54B acquires the result of verification performed by the data verification unit 54A and the error rate measured by the error rate counting unit 53A, and determines a write current value to be applied to the zone from the write current values used for the sections SEC 0 to SEC 3 of the sector SCT or the write current value preset in the zone to which the sector SCT belongs (step S306). Further, the write current determination process of the write current determination unit 54B in step S306 follows the flowchart of FIG. 4 described above.

Thus, the write current optimization process in the magnetic disk device 1 according to the third embodiment ends.

The magnetic disk device 1 according to the third embodiment also achieves the same effect as that of the first embodiment.

### Other Embodiments

In the first to third embodiments described above, in the optimization process of the write current value, the minimum write current value among the write current values whose error rate is within the predetermined threshold value is applied to the zone of the optimization process target, but the present disclosure is not limited thereto. A suitable write current value may be set freely, for example, by applying a write current value that is the second smallest from the minimum write current value to the zone of the optimization process target among the write current values whose error rate is within the predetermined threshold value.

In the first to third embodiments described above, the optimization process of the write current value is performed, but the present disclosure is not limited thereto. As described above, the write current includes various setting parameters such as an overshoot current value, an overshoot maintenance time, and waveform start and end timings in addition to the write current value. Some of these setting parameters may be incorporated in the optimization process condition stored in the storage unit so that not only the write current value but also a plurality of setting parameters may be optimized. At this time, it is preferable to set the setting parameter that minimizes the data deterioration of the adjacent track as a suitable setting parameter. It should be noted that as described above, a suitable setting parameter may be set freely. For example, in step S114 in the flow of FIG. 4, instead of determining only the minimum write current value, an average value of the write current waveforms determined based on various setting parameters and a parameter that minimizes a peak value of the write current waveform may also be determined. Accordingly, the setting value of the write current shown in FIG. 4 or the like may include not only the write current value but also other setting parameters related to the write current. In addition, the setting value of the write current is not necessarily a numerical value, and may include the setting of the write current itself and also the relative contents such as a scale.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device, comprising:
a magnetic disk that includes a plurality of zones divided in a radial direction, a plurality of tracks in each of the zones, and a plurality of sectors in each of the tracks divided in a circumferential direction;
a magnetic head configured to read and write data to and from the magnetic disk; and
a control unit configured to determine a setting value of a recording current to be applied to the magnetic head when writing to each of a plurality of sections of a first sector, based on error rates in data read from a second sector that is in the same zone as the first sector and to which a write was performed while changing setting values of recording currents applied to the magnetic head while writing to each of a plurality of sections of the second sector.

2. The magnetic disk device according to claim 1, further comprising:
a temperature sensor configured to measure an internal temperature of the magnetic disk device, wherein
the control unit determines the setting value of the recording current to be applied to the magnetic head when writing to each of the plurality of sections of the first sector upon determining that the measured internal temperature differs from a previous temperature at which the control unit previously determined the setting value of the recording current to be applied to the magnetic head when writing to each of the plurality of sections of the first sector, by more than a predetermined threshold.

3. The magnetic disk device according to claim 2, wherein the control circuit performs a verification on the data read from the second sector to measure an error rate in the data read from the second sector for each of the sections of the second sector, and selects, as a recording current to be applied to the magnetic head when writing to each of the sections of the first sector, the recording current applied to the magnetic head while writing to a corresponding section of the second sector if the error rate in the data read from the corresponding section of the second sector is less than a threshold value.

4. The magnetic disk device according to claim 3, wherein the control circuit does not change the recording current to be applied to the magnetic head when writing to each of the sections of the first sector if the error rate in the data read from the corresponding section of the second sector is greater than the threshold value.

5. The magnetic disk device according to claim 2, wherein the control circuit does not change the recording current to be applied to the magnetic head when writing to each of the sections of the first sector if the measured internal temperature differs from the previous temperature at which the control unit determined the setting value of the recording current to be applied to the magnetic head when writing to each of the plurality of sections of the first sector, by less than the predetermined threshold.

6. The magnetic disk device according to claim 1, wherein the control circuit determines a default setting value as the setting value of the recording current to be applied to the magnetic head when writing to each of the plurality of sections of a third sector that is in the same sector as the second sector if the error rates in data read from the second sector indicate that the data is not correctly written to the second sector.

7. The magnetic disk device according to claim 1,
wherein the data to be written to the first sector is received along with a write command transferred from a host.

8. The magnetic disk device according to claim 1,
wherein the data to be written to the first sector, which is of a first track, is data read from a third sector of a second track in connection with a refresh process.

9. The magnetic disk device according to claim 1,
wherein the data to be written to the first sector, which is of a first track, is data read from a third sector of a second track that has been subject to a retry process a predetermined number of times or more.

10. A method of determining a setting value of a recording current to be applied when writing to each of a plurality of sections of a first sector of a magnetic disk of a magnetic disk device having a magnetic head configured to read and write data to and from the magnetic disk, wherein the magnetic disk includes a plurality of zones divided in a radial direction, a plurality of tracks in each of the zones, and a plurality of sectors in each of the tracks divided in a circumferential direction, said method comprising:
performing a write to a second sector that is in the same zone as the first sector while changing setting values of recording currents applied to the magnetic head while writing to each of a plurality of sections of the second sector; and
determining the setting value of the recording current to be applied to the magnetic head when writing to each of a plurality of sections of the first sector, based on error rates in data read from the second sector.

11. The method according to claim 10, further comprising:
measuring an internal temperature of the magnetic disk device; and
upon determining that the measured internal temperature differs from a previous temperature at which the control unit determined the setting value of the recording current to be applied to the magnetic head when writing to each of the plurality of sections of the first sector, by more than a predetermined threshold, determining the setting value of the recording current to be applied to the magnetic head when writing to each of the plurality of sections of the first sector.

12. The method according to claim 11, further comprising:
after performing the write to the second sector, performing a read on the second sector and a verification on the data read from the second sector to measure an error rate in the data read from the second sector for each of the sections of the second sector, and selecting, as a recording current to be applied to the magnetic head when writing to each of the sections of the first sector, the recording current applied to the magnetic head while writing to a corresponding section of the second sector if the error rate in the data read from the corresponding section of the second sector is less than a threshold value.

13. The method according to claim 12, wherein the recording current to be applied to the magnetic head when writing to each of the sections of the first sector is not changed if the error rate in the data read from the corresponding section of the second sector is greater than the threshold value.

14. The method according to claim 11, wherein the recording current to be applied to the magnetic head when writing to each of the sections of the first sector is not changed if the measured internal temperature differs from the previous temperature at which the control unit determined the setting value of the recording current to be applied to the magnetic head when writing to each of the plurality of sections of the first sector, by less than the predetermined threshold.

15. The method according to claim 10, further comprising:
determining a default setting value as the setting value of the recording current to be applied to the magnetic head when writing to each of the plurality of sections of a third sector that is in the same zone as the second sector if the error rates in data read from the second sector indicate that the data is not correctly written to the second sector.

16. The method according to claim 10,
wherein the data to be written to the first sector is received along with a write command transferred from a host.

17. The method according to claim 10,
wherein the data to be written to the first sector, which is of a first track, is data read from a third sector of a second track in connection with a refresh process.

18. The method according to claim 10,
wherein the data to be written to the first sector, which is of a first track, is data read from a third sector of a second track that has been subject to a retry process a predetermined number of times or more.
